(19) United States
(12) Patent Application Publication
(10) Pub. No.: US 2026/0313401 A1
(43) Pub. Date: Oct. 8, 2026

(54) SYSTEMS AND METHODS FOR DISTURBANCE DETECTION WITHIN NETWORKS

(71) Applicant: Verizon Patent and Licensing Inc., Basking Ridge, NJ (US)

(72) Inventor: Scott Kotrla, Wylie, TX (US)

(21) Appl. No.: 19/171,652

(22) Filed: Apr. 7, 2025

(51) Int. Cl. H04W 24/04

(52) U.S. Cl. CPC H04W 24/04

(57) ABSTRACT

A low resolution event detection is performed at a first sensing resolution over a network that includes a plurality of communication segments. In response to the low resolution event detection identifying a potential disturbance along a communication segment, a high resolution event detection is triggered at a second sensing resolution. The high resolution event detection involves a scan that collects sensing information for the communication segment. The sensing information is evaluated to determine a risk score for the communication segment. A remedial action is performed for the communication segment if the risk score exceeds a threshold.

### BACKGROUND

A network includes various network equipment, transmission equipment, and/or cabling that provides user equipment with connectivity and communication capabilities over the network. For example, the network may provide wired communication through cooper cables, fiber optic cables, or other types of cables. The cabling is used to transmit information from one location in the network to another location in the network. The transmission equipment may include transponders that receive and retransmit signals over fiber optic cables.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for disturbance detection within networks, in accordance with an embodiment of the present technology;

FIG. 2 illustrates an example of a method for disturbance detection within networks using low resolution event detection and high resolution event detection, in accordance with an embodiment of the present technology;

FIGS. 3A-3C illustrate examples of systems for disturbance detection within networks using low resolution event detection and high resolution event detection, in accordance with an embodiment of the present technology;

FIG. 4 illustrates an example of a method for disturbance detection within networks using dedicated sensing operations, in accordance with an embodiment of the present technology;

FIGS. 5A-5B illustrate examples of systems for disturbance detection within networks using dedicated sensing operations, in accordance with an embodiment of the present technology;

FIG. 6 is an illustration of a scenario featuring an example non-transitory machine readable medium in accordance with one or more of the provisions set forth herein.

FIG. 7 is an illustration of example networks that may utilize and/or implement at least a portion of the techniques presented herein;

FIG. 8 is an illustration of a scenario involving an example configuration of a computer that may utilize and/or implement at least a portion of the techniques presented herein;

FIG. 9 is an illustration of a scenario involving an example configuration of a client that may utilize and/or implement at least a portion of the techniques presented herein;

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

Systems and methods are provided for disturbance detection within networks. A network includes network equipment, cabling, and/or other components that may be affected by disturbances that can cause failures or disruptions in service to user equipment connected to the network. For example, the network may include fiber optic cabling that may transmit signals between network equipment, such as between buildings within a downtown area of a city. The fiber optic cabling may be buried underground between the buildings. If there is digging near the fiber optic cabling, then the digging could end up cutting the fiber optic cabling. This could result in a disruption of service for user equipment that were previously communicating over the fiber optic cabling before the damage occurred. The disruption may last until the fiber optic cabling has been repaired and service has been restored. This outage is disruptive and affects the operation of user equipment, services, applications, and/or other functionality that were communicating over the fiber optic cabling. Typical fiber sensing techniques may be used to detect disturbances within the network, but can be slow and result in prolonged service disruptions due to delays in dispatching a repair team. The typical fiber sensing techniques have limited sensing distances and may be limited due to the use of amplifiers that block certain sensing techniques.

The disclosed techniques improve the resiliency of networks through fast and early detection of disturbances so that damage to the network can be preemptively avoided or quickly repaired by reducing the time to detect and respond to the disturbances. That is, the disclosed techniques can more quickly detect and respond to disturbances so that a response team can be dispatched quickly to address the disturbance before damaged is caused (e.g., dispatch of a service technician to warn a crew that is digging near a fiber optic cable) or to quickly repair any damage such as to repair a cut fiber optic cable.

In some embodiments, low resolution event detection is performed at a first sensing resolution over a network that includes communication segments such as fiber optic cabling between network equipment. For example, feed-forward type fiber sensing may be performed at relatively lower resolution event detection (e.g., sensing over 10 km along multiple fiber paths at a time such as over a Dense Wavelength-Division Multiplexing system with detection times under 1 second). In response to the low resolution event detection identifying a potential disturbance along a communication segment, high resolution event detection is triggered. The high resolution event detection performs a scan of the particular communication segment at a second sensing resolution higher than the first sensing resolution. For example, a backscattering type fiber sensing is performed at a relatively higher resolution event detect (e.g., sensing over 1 m of a single fiber path at a time).

The scan collects sensing information that is evaluated to determine a risk score for the communication segment. The risk score may take into account how likely the potential disruption will interfere with operation of the communication segment, such as a potential that the digging will damage the fiber optic cabling. The risk score may take into account whether there has been prior problems with the communication segment such as prior instances of the fiber optic cabling being damaged or failing (e.g., prior issues may increase the risk score). The risk score may take into account whether there are any permits or information regarding activities or work being performed near the communication segment (e.g., a dig permit may lower the risk score because the digging crew may be aware of utility information). If the risk score exceeds a threshold, then a remedial action may be performed such as to dispatch a crew to investigate the communication segment.

In some embodiments, dedicated fiber sensing equipment is used to perform sensing at a high enough accuracy that an output can be used to determine whether to perform the remedial action. For example, the dedicated fiber sensing equipment may be purpose built feed-forward type fiber sensing equipment (feed-forward fiber sensing equipment) that can sample phase changes fast enough for a resolution (e.g., 10 meter resolution) that provides enough accuracy for determining whether to perform the remedial action (e.g., a high enough confidence that a detected disturbance is indeed an actual disturbance and is a disturbance posing a risk to the communication segment). Signals used by the dedicated fiber sensing equipment may start and stop at a same node in the network to eliminate any synchronization dependencies for the signals for which the phase changes are being sampled. Because the dedicated fiber sensing equipment is not additionally carrying normal communication signal traffic (e.g., communication traffic of user equipment), the dedicated fiber sensing equipment provides adequate accuracy for determining whether to perform a remedial action without additionally leveraging backscattering type fiber sensing equipment.

The disclosed techniques improve upon existing event detection techniques by more quickly and more accurately detecting disturbances within a network. Early detection of disturbances with a high enough accuracy for determining whether to perform a remedial action provides the ability to quickly or preemptively respond to potential disturbances that could result in service outages, thus improving the resiliency and operation of the network.

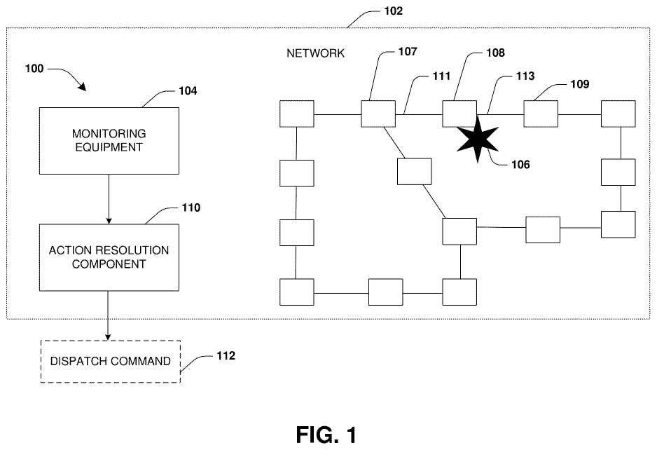

FIG. 1 illustrates an example of a system 100 for disturbance detection within networks. The system 100 may be deployed as part of a network 102 that provides communication and/or other network functionality to user equipment connected to the network 102. In some embodiments, the network 102 may include communication segments (e.g., fiber optic cabling) that connects network equipment located at different locations, such as at different buildings within a downtown area. For example, a communication segment 111 may include fiber optic cabling that connects network equipment in building 107 to network equipment in building 108, and a communication segment 113 may include fiber optic cabling that connects network equipment in building 108 to network equipment in building 109. The network 102 may include various network equipment, such as transponders that receive and retransmit optical signals over the network 102.

The system 100 may include monitoring equipment 104 and/or an action resolution component 110. In some embodiments, the monitoring equipment 104 may be installed at various locations (nodes) associated with the network 102, such as at or nearby the different buildings or other locations where network equipment and/or user equipment may connect to the network 102, for example. That is, even though monitoring equipment 104 is depicted as a single component in FIG. 1, there may be multiple different instances of various types of monitoring equipment dispersed around the network 102.

In some embodiments, the monitoring equipment 104 may include sensing equipment that can perform low resolution event detection at a first sensing resolution (e.g., feed-forward type fiber sensing that provides 10 km low resolution event detection through multiple fiber paths at a time). In some embodiments, the monitoring equipment 104 may include sensing equipment that can perform high resolution event detection at a second sensing resolution (e.g., a backscattering type fiber sensing that provides 1 m sensing of a single fiber path, such as over dark fiber). In some embodiments, the monitoring equipment 104 may include dedicated sensing equipment capable of sampling phase changes over the network 102 fast enough for a sensing resolution that is accurate enough to be used for determining whether there is a potential disturbance to investigate (e.g., purpose built feed-forward type fiber sensing equipment that starts and stops signals from a same location, and does not carry or process normal communication traffic over the network 102).

In some embodiments, the monitoring equipment 104 may detect a potential disturbance 106 near the communication segment 113 between the building 108 and the building 109. The monitoring equipment 104 may generate sensing information for the detected potential disturbance 106, which is provided to an action resolution component 110. In some embodiments, the action resolution component 110 may determine a risk score for the communication segment 113 based upon the sensing information. The risk score may be indicative of a risk that the potential disturbance could result in damage to the communication segment 113 or cause a disruption that hinders the ability of the communication segment 113 to operate correctly (e.g., cause degraded performance). If the risk score exceeds a threshold, then the action resolution component 110 may perform a remedial action such as issuing a dispatch command 112 to trigger an investigation of the potential disturbance 106. If the risk score does not exceed the threshold, then the action resolution component 110 may forgo performing the remedial action to conserve resources and cost. In some embodiments where dedicated sensing equipment detects the potential disturbance 106, the action resolution component 110 takes into consideration a confidence that the potential disturbance was accurately detected. If the confidence is below an accuracy threshold, then the action resolution component 110 forgoes performing the remedial action.

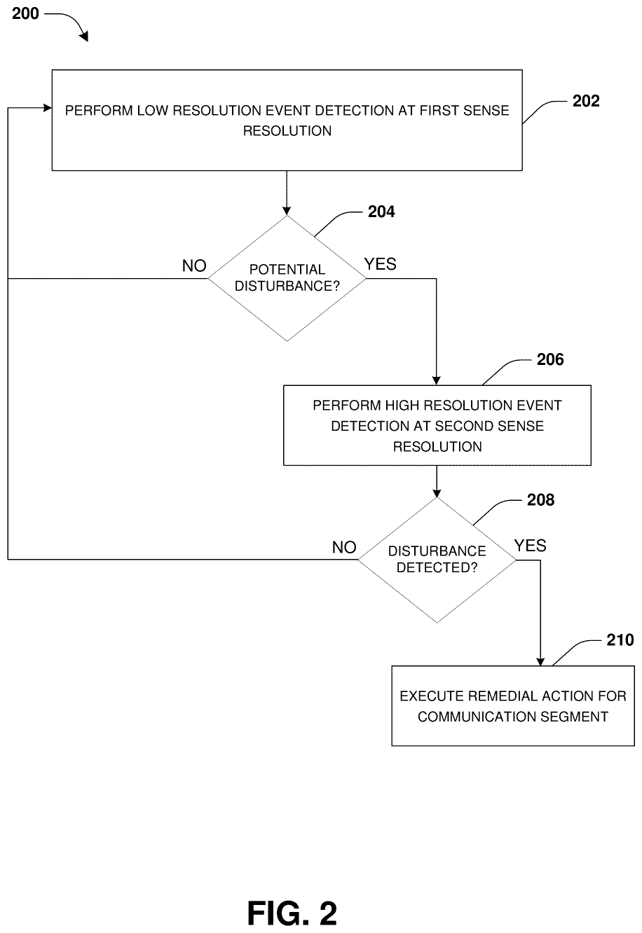

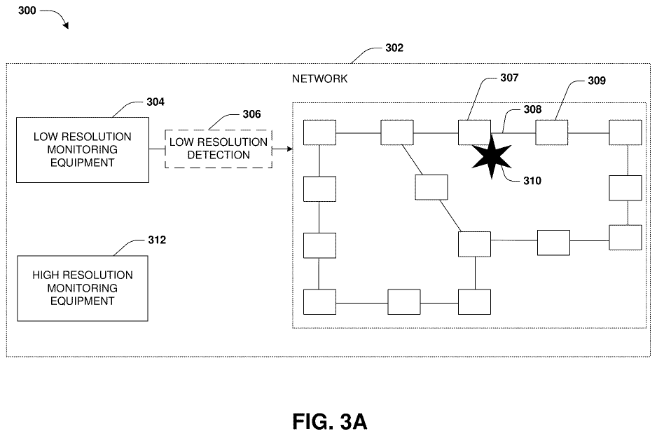

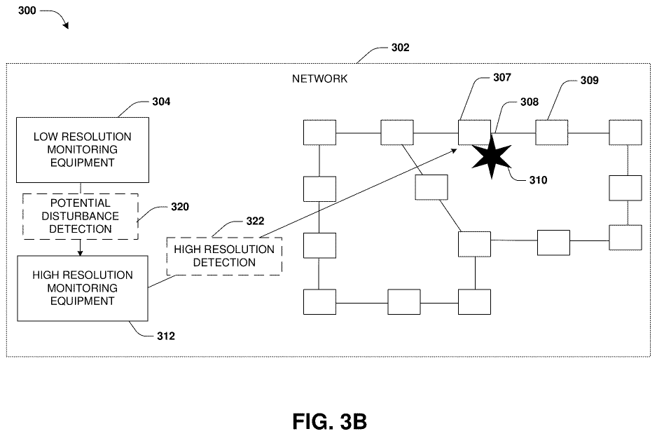

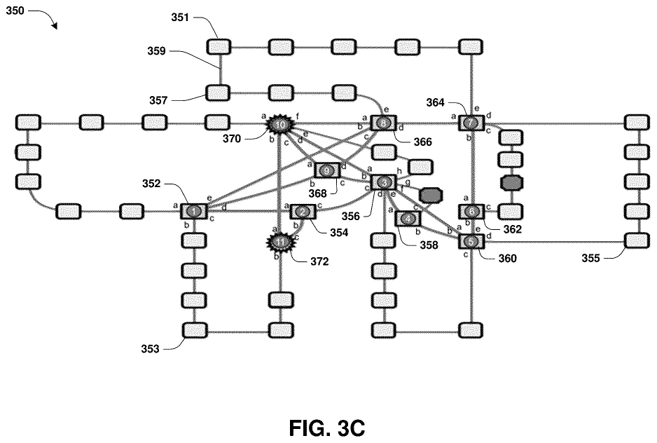

FIG. 2 illustrates an example of a method 200 for disturbance detection within networks using low resolution event detection and high resolution event detection, which is described in conjunction with system 300 of FIGS. 3A and 3B and system 350 of FIG. 3C. The system 300 may include low resolution monitoring equipment 304 and/or high resolution monitoring equipment 312 for monitoring a network 302, as illustrated by FIG. 3A. The network 302 includes network equipment that provides communication services to user equipment, such as computers or other electronic devices. The network equipment, such as transponders, may be positioned at various locations around the network 302 such as a first location 307 connected to a second location 309 by a communication segment 308 such as fiber optic cabling connecting the network equipment at the two locations.

During operation 202 of method 200, the low resolution monitoring equipment 304 performs low resolution event detection 306 at a first sensing resolution over the network 302 that includes a plurality of communication segments such as the communication segment 308. In some embodiments where the low resolution monitoring equipment 304 is associated with a transponder, the transponder is controlled to perform feed-forward fiber sensing for one or more of the communication segments for detecting potential disturbances along the one or more communication segments (e.g., detection of a car, a train, digging, or other vibration proximate a communication segment). In some embodiments where the low resolution monitoring equipment 304 is associated with a feed-forward coherent transponder, the feed-forward coherent transponder is controlled to sense one or more of the communication segments for detecting potential disturbances along the one or more communication segments.

During operation 204 of method 200, a determination is made as to whether the low resolution event detection 306 identified a potential disturbance 310, such as where vibrations, energy, or other sensed information/signals are indicative of movement or activity that could disturb, damage, or otherwise affect a communication segment of the network 302 (e.g., a construction crew performing digging near fiber optic cabling). If no potential disturbance is detected, then the low resolution event detection 306 may continue to be performed such as on a continual or periodic basis.

As illustrated by FIG. 3B, if a potential disturbance 310 is detected 320 such as in relation to the communication segment 308, then the high resolution monitoring equipment 312 is triggered to perform a high resolution event detection at a second sensing resolution higher than the first sensing resolution, during operation 206 of method 200. In some embodiments, sensing equipment is controlled to perform a backscatter based fiber sensing for the particular communication segment 308 at the second sensing resolution. The high resolution event detection 322 may perform a scan that is isolated to target the communication segment 308 for collecting sensing information for the communication segment 308 based upon the low resolution event detection 306 identifying the potential disturbance 310 for the communication segment 308.

During operation 208 of method 200, a determination is made as to whether the sensing information is indicative of the potential disturbance 310. In some embodiments, the sensing information is evaluated to determine a risk score for the communication segment 308. In some embodiments, the risk score may be based upon a type of detected disturbance for the communication segment 308, such as where a high magnitude/strong disturbance indicative of digging poses more risk of affecting operation of or damaging the communication segment 308 compared to car traffic vibrations. In some embodiments, the risk score may be based upon an availability of information related to an activity being performed near the communication segment 308, such as whether a detected digging activity has a digging permit or not (e.g., the digging permit may indicate a lower risk because the diggers might have notice of nearby utility lines such as fiber optic cabling). In some embodiments, the risk score may be based upon a history of failures associated with the communication segment 308 (e.g., a history of the communication segment 308 previously failing such as due to being cut by digging, which may indicate a higher risk). In some embodiments, the sensing information and/or additional details, such as the history of failures, the availability of information related to the activity, etc., may be input into a decision support system hosted by an action resolution component to determine whether to perform a remedial action or not.

During operation 210 of method 200, a remedial action is executed based upon the risk score exceeding a threshold. In some embodiments, the decision support system is used to determine what type of remedial action to perform such whether to generate and execute a dispatch command to dispatch an investigation for the communication segment 308. If the risk score does not exceed the threshold, then the remedial action is not performed.

FIG. 3C illustrates an example of implementing disturbance detection for a network 350. The network 350 may include network locations where network equipment may be located, such as a first network location 351, a second network location 353, a third network location 355, a fourth network location 357, and/or other network locations represented as shapes/boxes. A network location may be associated with a node (e.g., a reconfigurable optical add-drop multiplexer). The nodes at the network locations are connected by fiber connectivity, such as where a fiber path 359 of fiber optic cabling connects the first network location 351 to the fourth network location 357. Network locations 352, 354, 356, 358, 360, 362, 364, 366, 368, 370, and 372 represent core sites in the network 350 where dedicated back-scattering fiber sensing test equipment is located and connected to dark fiber on each fiber path (a)-(h) leaving corresponding network locations. For example, network location 364 has a path (a) that is connected to path (d) of network location 366 without any intermediate locations there between. Path (e) of network location 364 has a second connection to path (e) of network location 366 that goes through 8 intermediate locations.

Each fiber optic cable is monitored by the back-scattering fiber sense test equipment through the 11 core locations over the dark fiber. Similarly, a collection of dense wavelength division multiplexing (DWDM) wavelengths supporting feed-forward fiber sensing are configured over the fiber spans (fiber paths) in the network 350 such that each DWDM wavelength begins and ends at the same network location. For example, fiber path (e) of network location 364 to fiber path (e) of network location 366, fiber path (a) of network location 366 to fiber path (f) of network location 370, fiber path (a) of network location 370 to fiber path (a) of network location 352, fiber path (b) of network location 352 to fiber path (b) of network location 372, fiber path (c) of network location 372 to fiber path (b) of network location 354, fiber path (c) of network location 354 to fiber path (c) of network location 356, fiber path (f) of network location 356 to fiber path (a) of network location 360, fiber path (e) of network location 360 to fiber path (b) of network location 362, and fiber path (a) of network location to fiber path (b) of network location 364 is a loop that starts and ends at network location 364. A single DWDM wavelength along the loop is 32 hops and is used for monitoring the 32 fiber paths between the network locations using feed-forward fiber sensing. Additional DWDM wavelengths can be positioned to cover the remaining portions of the network 350.

When a feed-forward fiber sensing DWDM wavelength detects an event in near real-time, such as during operation 204 of method 200, the sensing can localize the event to a specific fiber path (fiber span). The sensing automatically initiates/triggers a high-resolution back-scattering fiber sensing test from one or both ends of the fiber path depending on back-scattering fiber sensing test equipment resource available, as described in relation to operation 206 of method 200. For example, if an event is detected between the 4^{th} hop from fiber path (e) of network location 364 to fiber path (e) of network location 366, then back-scattering fiber sensing is initiated from network location 364 on fiber path (e) and/or network location 366 on fiber path (e).

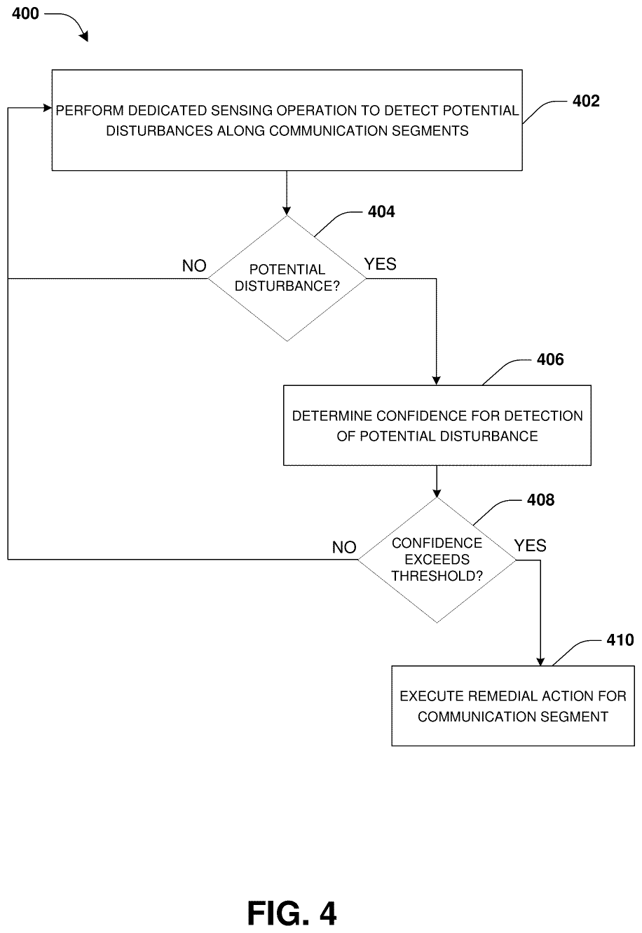

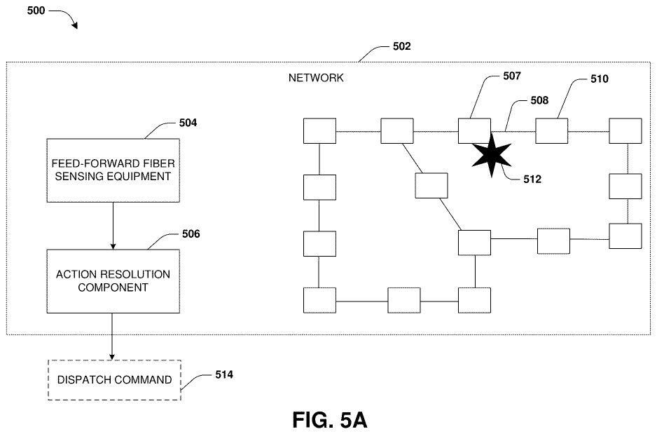

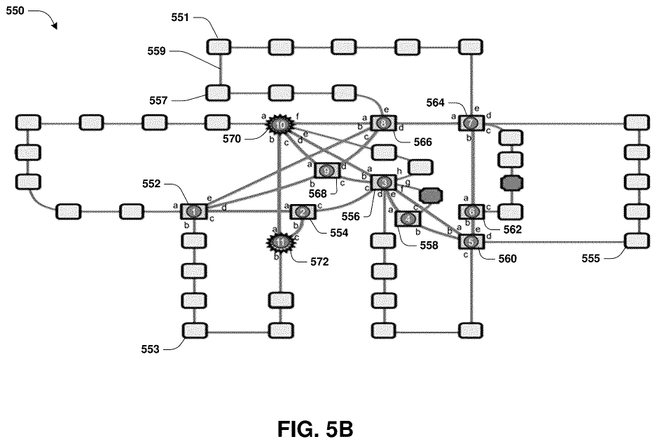

FIG. 4 illustrates an example of a method 400 for disturbance detection within networks using dedicated sensing operations, which is illustrated in conjunction with system 500 of FIG. 5A. The system 500 may include feed-forward fiber sensing equipment 504 for monitoring a network 502 and an action resolution component 506 for implementing remedial actions. For example, a feed-forward coherent transponder may be purpose built to implement the action resolution component 506 and/or the feed-forward fiber sensing equipment 504 as dedicated monitoring equipment. The dedicated monitoring equipment may be provided for generating dispatch commands to dispatch investigations for communication segments for which disturbances are identified.

The network 502 includes network equipment that provides communication services to user equipment, such as computers or other electronic devices. The network equipment, such as transponders, may be positioned at various locations around the network 502 such as a first location 507 connected to a second location 510 by a communication segment 508 such as fiber optic cabling connecting the network equipment at the two locations.

In some embodiments, the feed-forward fiber sensing equipment 504 is used to perform sensing at a high enough accuracy that an output can be used to determine whether to perform a remedial action. For example, the feed-forward fiber sensing equipment 504 may be purpose-built feed-forward type fiber sensing equipment that can sample phase changes fast enough for a resolution (e.g., 10 meter resolution) that provides a high enough sensing accuracy for determining whether to perform a remedial action or not. Signals used by the feed-forward fiber sensing equipment 504 may start and stop at a same node in the network 502, which eliminates any synchronization dependencies with respect to signals being generated as part of the phase change sampling by the feed-forward fiber sensing equipment 504. Because the feed-forward fiber sensing equipment 504 is dedicated test equipment that is not additionally carrying normal communication signal traffic such as user equipment communication, the feed-forward fiber sensing equipment 504 provides a high enough sensing accuracy for determining whether to perform a remedial action without additionally leveraging backscattering type fiber sensing equipment.

During operation 402 of method 400, the feed-forward fiber sensing equipment 504 performs a dedicated sensing operation to detect a potential disturbance along communication segments of the network 502. During operation 404 of method 400, a determination is made as to whether a potential disturbance was detected by the dedicated sensing operation. If a potential disturbance is detected (e.g., a potential disturbance 512 near the communication segment 508), then a confidence is determined for the detection of the potential disturbance, during operation 406 of method 400. The confidence relates to how accurately the potential disturbance was sensed/identified by the feed-forward fiber sensing equipment. For example, the confidence may relate to how accurate was the dedicated sensing operation, such as whether the feed-forward fiber sensing equipment 504 could sample phase changes fast enough for 10 m resolution or some other sensing resolution.

During operation 408 of method 400, the action resolution component 506 may determine whether to perform a remedial action based upon whether the confidence exceeds an accuracy threshold. If the confidence exceeds the accuracy threshold and/or whether a risk score exceeds a threshold, then the remedial action is performed, during operation 410 of method 400. In some embodiments of performing the remedial action, a dispatch command 514 is created and executed to dispatch an investigation of the potential disturbance 512.

FIG. 5B illustrates an example of the system implementing disturbance detection for a network 550. The network 550 may include network locations where network equipment may be located, such as a first network location 551, a second network location 553, a third network location 555, a fourth network location 557, and/or other network locations represented as shapes/boxes. A network location may be associated with a node (e.g., a reconfigurable optical add-drop multiplexer). The nodes at the network locations are connected by fiber connectivity, such as where a fiber path 559 of fiber optic cabling connects the first network location 551 to the fourth network location 557. Network locations 552, 554, 556, 558, 560, 562, 564, 566, 568, 570, and 572 represent core sites in the network 550 where fiber path (a)-(h) are leaving corresponding network locations. For example, network location 564 has a path (a) that is connected to path (d) of network location 566 without any intermediate locations there between. Path (e) of network location 564 has a second connection to path (e) of network location 566 that goes through 8 intermediate locations.

A collection of DWDM wavelengths supporting feed-forward fiber sensing can be configured over all fiber paths in network 550, where each DWDM wavelength begins and ends at the same location. For example, fiber path (e) of network location 564 to fiber path (e) of network location 566, fiber path (a) of network location 566 to fiber path (f) of network location 570, fiber path (a) of network location 570 to fiber path (a) of network location 552, fiber path (b) of network location 552 to fiber path (b) of network location 572, fiber path (c) of network location 572 to fiber path (b) of network location 554, fiber path (c) of network location 554 to fiber path (c) of network location 556, fiber path (f) of network location 556 to fiber path (a) of network location 560, fiber path (e) of network location 560 to fiber path (b) of network location 562, and fiber path (a) of network location to fiber path (b) of network location 564 is a loop that starts and ends at network location 564. A single DWDM wavelength along the loop is 32 hops and is used for monitoring the 32 fiber paths between the network locations using feed-forward fiber sensing. Additional DWDM wavelengths can be positioned to cover the remaining portions of the network 550.

When a high-resolution feed-forward fiber sensing DWDM wavelength detects an event in near real-time, such as during operation 404 of method 400, the sensing can localize the event to a specific segment of a specific fiber path (fiber span). A confidence in a level of risk of the event is determined, as described in relation to operation 406 of method 400.

The sensing automatically initiates/triggers a high-resolution back-scattering fiber sensing test from one or both ends of the fiber path depending on back-scattering fiber sensing test equipment resource available, as described in relation to operation 206 of method 200. For example, if an event is detected between the 4^{th} hop from fiber path (e) of network location 564 to fiber path (e) of network location 566, then back-scattering fiber sensing is initiated from network location 564 on fiber path (e) and/or network location 566 on fiber path (e). If the event is detected at 1010 m down to the 4^{th} hop between fiber path (e) of network location 364 and fiber path (e) of network location 366 and the level of risk exceeds the threshold, as part of operation 408 of method 400, then operation 410 of method 400 is executed with the 1010 m event localization

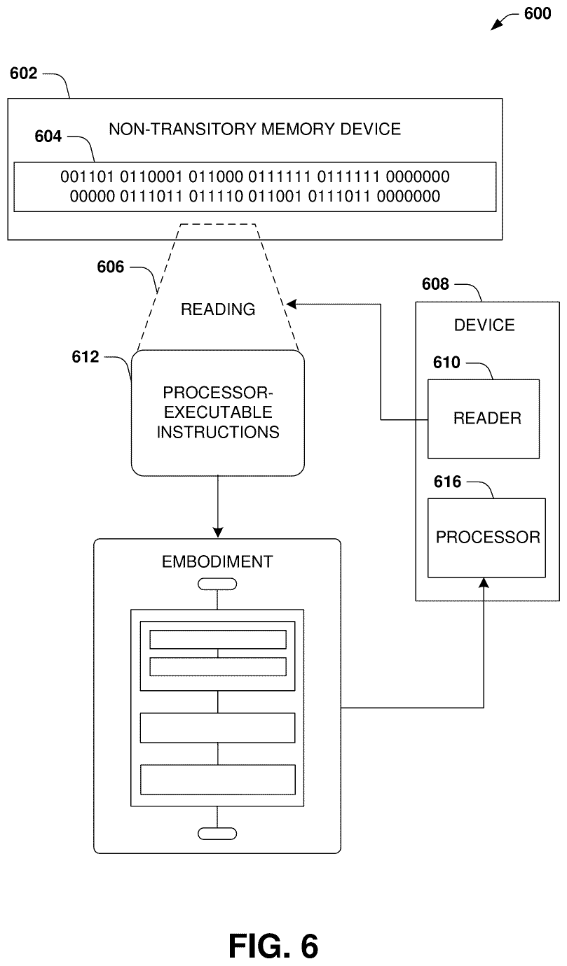

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2 and/or at least some of the example method 400 of FIG. 4, for example. In some embodiments, the processor-executable instructions 612 are configured to cause implementation of a system, such as at least some of the example system 100 of FIG. 1, at least some of the example systems of FIGS. 3A-3C, and/or at least some of the example systems of FIGS. 5A and 5B, for example.

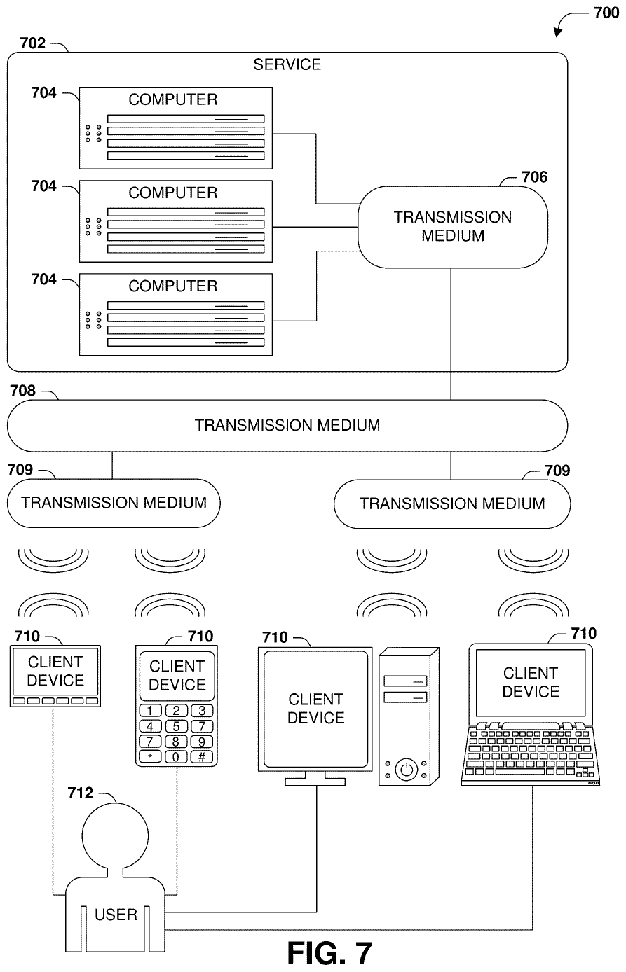

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

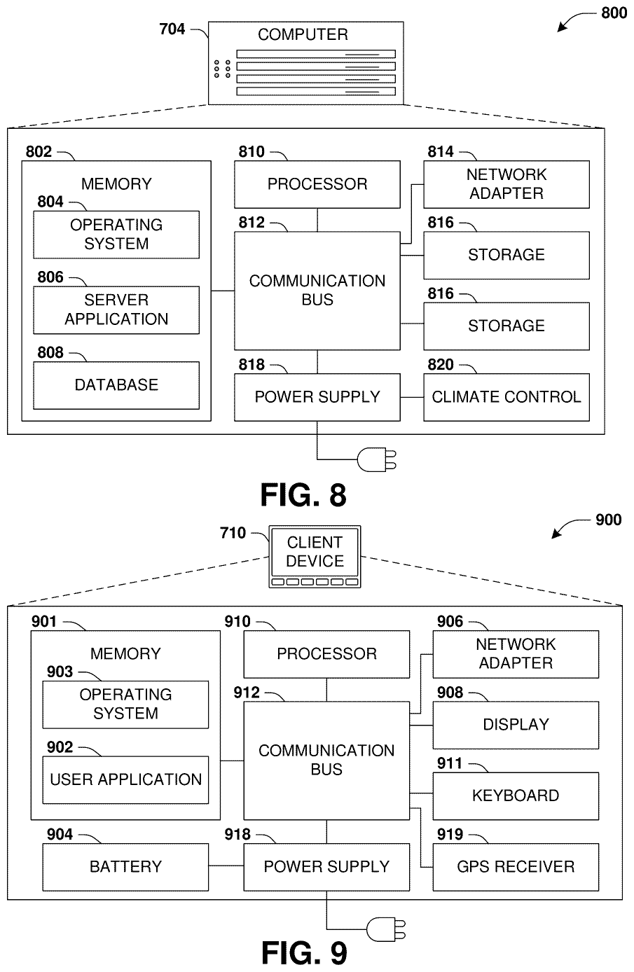

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
performing a low resolution event detection at a first sensing resolution over a network that includes a plurality of communication segments providing communication for devices connected to the network;
in response to the low resolution event detection identifying a potential disturbance along a communication segment of the plurality of communication segments, triggering execution of a high resolution event detection at a second sensing resolution higher than the first sensing resolution;
performing, by the high resolution event detection, a scan of the communication segment to collect sensing information for the communication segment;
evaluating the sensing information to determine a risk score for the communication segment; and
executing a remedial action for the communication segment based upon the risk score exceeding a threshold.

2. The method of claim 1, wherein the executing the remedial action comprises:
generating a dispatch command to dispatch an investigation for the communication segment.

3. The method of claim 1, wherein the performing the low resolution event detection comprises:
controlling a transponder to perform feed-forward fiber sensing for one or more communication segments of the plurality of communication segments for detecting potential disturbances along the one or more communication segments.

4. The method of claim 1, wherein the performing the scan by the high resolution event detection comprises:
controlling sensing equipment to perform backscatter based fiber sensing for the communication segment.

5. The method of claim 1, comprising:
determining the risk score based upon a type of detected disturbance for the communication segment.

6. The method of claim 1, comprising:
determining the risk score based upon an availability of information related to an activity being performed near the communication segment.

7. The method of claim 1, comprising:
determining the risk score based upon a history of failures associated with the communication segment.

8. The method of claim 1, wherein the evaluating the sensing information comprises:
inputting the sensing information into a decision support system to determine whether to dispatch an investigation for the communication segment.

9. The method of claim 1, wherein the evaluating the sensing information comprises:
isolating the high resolution event detection to target the communication segment based upon the low resolution event detection identifying the potential disturbance along the communication segment.

10. The method of claim 1, wherein the performing the low resolution event detection comprises:
controlling a feed-forward coherent transponder to sense one or more communication segments of the plurality of communication segments for detecting potential disturbances along the one or more communication segments.

11. A system, comprising:
one or more processors configured for executing instructions to perform operations comprising:
performing a low resolution event detection at a first sensing resolution over a network that includes a plurality of communication segments providing communication for devices connected to the network;
in response to the low resolution event detection identifying a potential disturbance along a communication segment of the plurality of communication segments, triggering execution of a high resolution event detection at a second sensing resolution higher than the first sensing resolution;
performing, by the high resolution event detection, a scan of the communication segment to collect sensing information for the communication segment;
evaluating the sensing information to determine a risk score for the communication segment; and
executing a remedial action for the communication segment based upon the risk score exceeding a threshold.

12. The system of claim 11, wherein the operations further comprise:
generating a dispatch command to dispatch an investigation for the communication segment.

13. The system of claim 11, wherein the operations further comprise:
controlling a transponder to perform feed-forward fiber sensing for one or more communication segments of the plurality of communication segments for detecting potential disturbances along the one or more communication segments.

14. The system of claim 11, wherein the operations further comprise:
controlling sensing equipment to perform backscatter based fiber sensing for the communication segment.

15. The system of claim 11, wherein the operations further comprise:
inputting the sensing information into a decision support system to determine whether to dispatch an investigation for the communication segment.

16. The system of claim 11, wherein the operations further comprise:
isolating the high resolution event detection to target the communication segment based upon the low resolution event detection identifying the potential disturbance along the communication segment.

17. The system of claim 11, wherein the operations further comprise:
controlling a feed-forward coherent transponder to sense one or more communication segments of the plurality of communication segments for detecting potential disturbances along the one or more communication segments.

18. A system, comprising:
feed-forward fiber sensing equipment connected to a network that includes a plurality of communication segments providing communication for devices connected to the network, wherein the feed-forward fiber sensing equipment performs a dedicated sensing operation to detect a potential disturbance along the plurality of communication segments; and
an action resolution component that:
determines whether to perform a remedial action based upon a confidence that the potential disturbance was accurately detected; and
performs the remedial action based upon the confidence exceeding an accuracy threshold.

19. The system of claim 18, wherein the feed-forward fiber sensing equipment starts and stops a dedicated sensing operation signal from a same node within the network.

20. The system of claim 18, wherein a feed-forward coherent transponder implements the feed-forward fiber sensing equipment and the action resolution component, and wherein the feed-forward coherent transponder generates a dispatch command to dispatch an investigation for the communication segment.
